(19) United States
(12) Patent Application Publication
(10) Pub. No.: US 2011/0086592 A1
(43) Pub. Date: Apr. 14, 2011

(54) METHOD FOR DISPLAYING CALENDAR DATA

(75) Inventor: Jung-Eun LEE, Gumi-si (KR)

(73) Assignee: SAMSUNG ELECTRONICS CO. LTD., Suwon-si (KR)

(21) Appl. No.: 12/900,703

(22) Filed: Oct. 8, 2010

(30) Foreign Application Priority Data
Oct. 13, 2009 (KR) 10-2009-0097096

(51) Int. Cl. H04B 7/00

(52) U.S. Cl. 455/41.2

(57) ABSTRACT

A method and portable terminal for displaying calendar data in by indicating an owner of the calendar data is provided. The method includes generating, by a portable terminal, calendar data where IDentification (ID) information of the portable terminal is stored, transmitting, by the portable terminal, the generated calendar data to a partner portable terminal, and indicating that the displayed calendar data is calendar data of a user of the portable terminal by using the ID information of the portable terminal, when displaying the transmitted calendar data in the partner portable terminal.

### PRIORITY

This application claims the benefit under 35 U.S.C. §119(a) of a Korean patent application filed in the Korean Intellectual Property Office on Oct. 13, 2009 and assigned Serial No. 10-2009-0097096, the entire disclosure of which is hereby incorporated by reference.

### BACKGROUND OF THE INVENTION

1. Field of the Invention

The present invention relates to a method for displaying calendar data. More particularly, the present invention relates to a method for displaying calendar data in a portable terminal, in which an owner of the calendar data is indicated.

2. Description of the Related Art

A calendar format, referred to as vCalendar, which is currently provided in terminals, is designed to allow users of different calendar data or scheduling programs to share scheduling information by providing an electronic calendaring and scheduling format.

The calendar format consists of data strings and to-do-items, and an event schedule is expressed in a predetermined style.

However, since only calendar data is displayed while the calendar is being displayed, a user cannot know if the displayed calendar is his calendar or a received and stored calendar of another user.

That is, the conventional calendar format has no concept of an “owner”, and thus a user's calendar and a calendar of another user are not displayed differently. Accordingly, the user cannot know the owner of the displayed calendar. Consequently, the concept of an exchange diary is not implemented in the vCalendar calendar format.

### SUMMARY OF THE INVENTION

An aspect of the present invention is to address at least the above-mentioned problems and/or disadvantages and to provide at least the advantages described below. Accordingly, an aspect of the present invention is to provide a method for displaying calendar data in a portable terminal, in which an owner of the calendar data is indicated.

In accordance with an aspect of the present invention, a method for displaying calendar data in a portable terminal is provided. The method includes generating, by a portable terminal, calendar data where IDentification (ID) information of the portable terminal is stored, transmitting, by the portable terminal, the generated calendar data to a partner portable terminal, and indicating that the displayed calendar data is calendar data of a user of the portable terminal by using the ID information of the portable terminal, when displaying the transmitted calendar data in the partner portable terminal.

In accordance with another aspect of the present invention, portable terminal for displaying calendar data is provided. The terminal includes a display for displaying calendar data to a user, an input unit for receiving an input from the user, at one least one of a wired and wireless communication unit for connecting and communicating with a partner portable terminal, and a controller for controlling to receive calendar data generated by the partner portable terminal and for controlling to display the received calendar data with an indication that the displayed calendar data is calendar data of a user of the partner portable terminal based on ID information of the partner portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiment of the present invention will be more apparent from the following description taken in conjunction with the accompanying drawings, in which:

FIG. 1 is a block diagram of a portable terminal according to an exemplary embodiment of the present invention; and

FIG. 2 is a flowchart showing a process of displaying calendar data and a user of a portable terminal which generates the calendar data according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

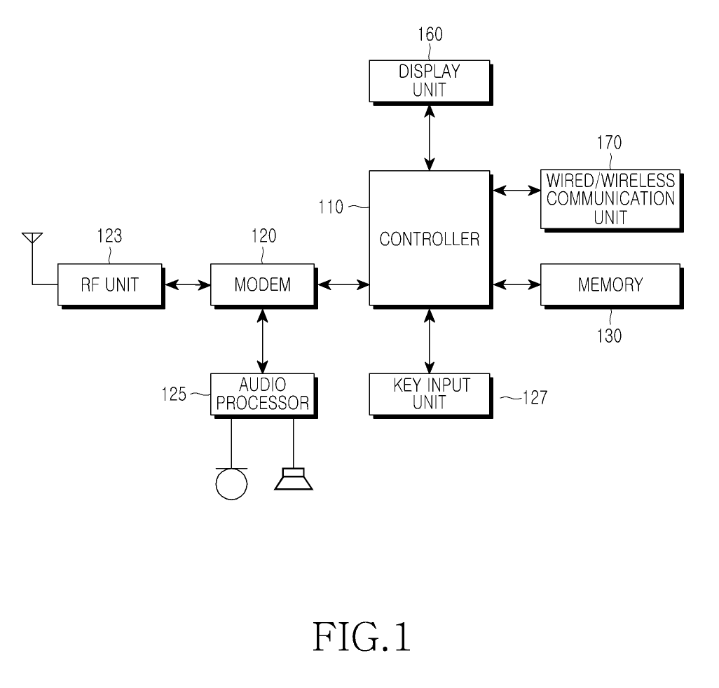

FIG. 1 is a block diagram of a portable terminal according to an exemplary embodiment of the present invention.

Referring to FIG. 1, a Radio Frequency (RF) unit 123 performs a wireless communication function for the portable terminal. The RF unit 123 includes an RF transmitter for up-converting and amplifying a frequency of a signal to be transmitted and an RF receiver for low-noise amplifying and down-converting a frequency of a received signal. A modem 120 includes a transmitter for encoding and modulating the signal to be transmitted and a receiver for demodulating and decoding the received signal. An audio processor 125 may form a codec which includes a data codec for processing packet data and an audio codec for processing an audio signal such as voice. The audio processor 125 converts a digital audio signal received from the modem 120 into an analog signal through the audio codec and reproduces the audio signal, or converts an analog signal generated and transmitted from a microphone into a digital audio signal through the audio codec and delivers the digital audio signal to the modem 120. The codec may be a separate unit or a built-in element of a controller 110.

A memory 130 includes a program memory and a data memory. The program memory stores programs for controlling a general operation of the portable terminal, and the data memory stores data generated during execution of the programs.

The memory 130 according to an exemplary embodiment of the present invention may store calendar data, in an owner field of which IDentification (ID) information of the portable terminal is stored. The memory 130 according to an exemplary embodiment of the present invention may also identify a partner portable terminal connected through a wired/wireless communication unit 170 by using the ID information, and may store the ID information in a calendar data list.

A display unit 160 displays user data output from the controller 110. The display unit 160 may be a Liquid Crystal Display (LCD), and in this case, the display unit 160 may include an LCD controller, a memory for storing image data, and an LCD display element. When the LCD is implemented as a touch screen, it may also operate as an input unit. The display unit 160 according to an exemplary embodiment of the present invention displays calendar data selected in a calendar view mode and displays a user of a portable terminal which generates the displayed calendar data.

A key input unit 127 includes keys for inputting number and character information and functional keys for setting various functions.

The wired/wireless communication unit 170 allows the portable terminal to be connected with the partner portable terminal for data exchange there between. The wired/wireless communication unit 170 according to an exemplary embodiment of the present invention may perform one or more of cable, Bluetooth, infrared communications, etc.

The controller 110 controls an overall operation of the portable terminal, and may include the modem 120 and the codec.

The controller 110 according to an exemplary embodiment of the present invention controls the ID information of the portable terminal to be stored in the owner field of the calendar data when the calendar data is generated.

The ID information may be a Bluetooth address of the portable terminal or an ID number of the portable terminal, and the controller 110 may transmit the ID information of the portable terminal to the partner portable terminal connected through the wired/wireless communication unit 170.

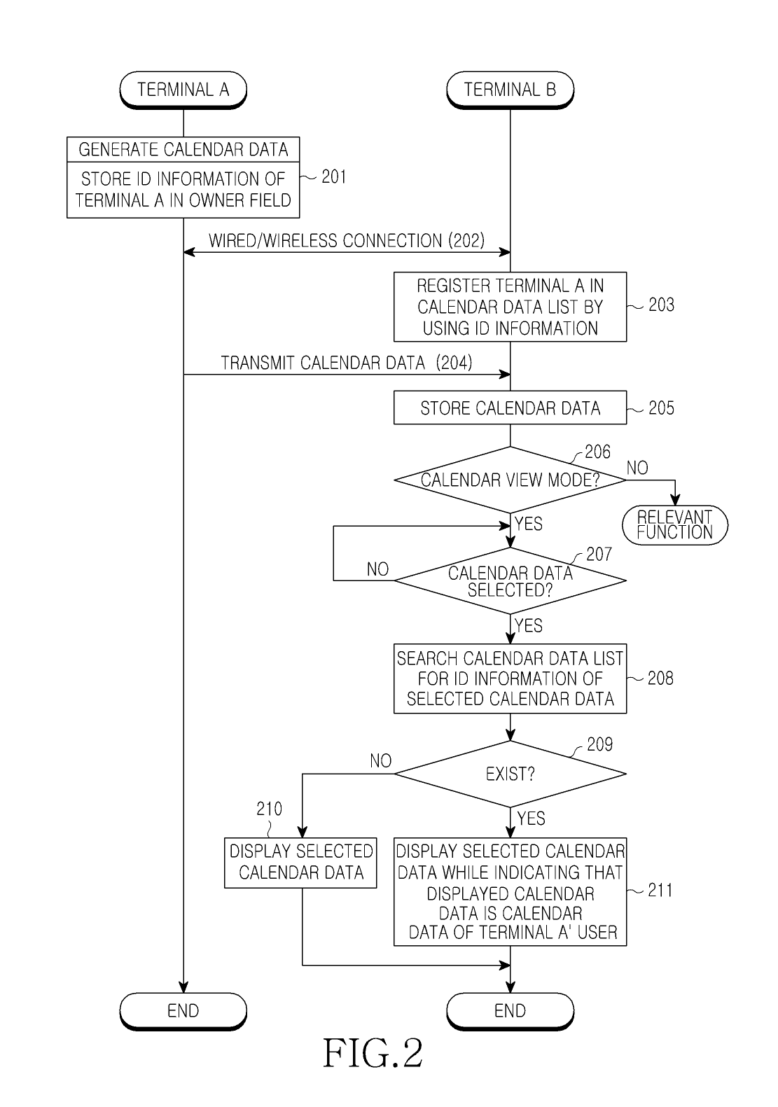

A calendar display operation in the portable terminal will be described below with reference to FIG. 2.

In an exemplary embodiment of the present invention, calendar data includes a schedule, to-do-items, and an event schedule. Although a portable terminal B may be structured as shown in FIG. 1 in an exemplary embodiment of the present invention, a portable terminal A may also be structured as shown in FIG. 1.

FIG. 2 is a flowchart showing a process of displaying calendar data and a user of a portable terminal which generates the calendar data according to an exemplary embodiment of the present invention.

With reference to FIGS. 1 and 2, a detailed description will be made of an exemplary embodiment of the present invention.

Referring to FIG. 2, if calendar data generation is selected in a calendar data mode of the portable terminal A, a controller of the portable terminal A detects the selection and generates the calendar data by storing ID information of the portable terminal A in an owner field of the calendar data in step 201.

Shown below is a format of the calendar data generated in step 201 in which the owner field may be inserted in any position between (a) and (b).
--vCalendar
Content-Type:text/x-vCalendar; charset=us-ascii; name=“MARTIN.VCS”
BEGIN:VCALENDAR
VERSION:1.0
BEGIN:VEVENT =>(a)
CATEGORIES:MEETING
STATUS:NEEDS ACTION
DTSTART:19960401T073000Z
DTEND:19960401T083000Z
SUMMARY:Steve's Proposal Review
DESCRIPTION:Steve and John to review newest proposal material
CLASS:PRIVATE
OWNER: TERMINAL ID INFORMATION
END:VEVENT =>(b)
BEGIN:VTODO
SUMMARY:John to pay for lunch
DUE:19960401T083000Z
STATUS:NEEDS ACTION
END:VTODO
END:VCALENDAR
--vCalendar—

The ID information may be a Bluetooth address of the portable terminal A or an ID number of the portable terminal A. The controller of the portable terminal A may transmit the ID information of the portable terminal A to the connected portable terminal B through the wired/wireless communication unit 170 of the portable terminal A.

For example, if the portable terminal A is connected with the portable terminal B by a cable or wireless communication, the portable terminal A transmits its ID number as the ID information to the portable terminal B. If the portable terminal A is connected with the portable terminal B by Bluetooth communication, the portable terminal B may use a Bluetooth address of the portable terminal A, acquired by Bluetooth communication, as the ID information. Also, the controller of the portable terminal A may transmit the ID information of the portable terminal A to the connected portable terminal B through the RF unit 123 of the portable terminal A

Once the portable terminal A is connected with the portable terminal B through the wired/wireless communication unit 170 or RF unit 123 in step 202, the controller 110 of the portable terminal B registers the portable terminal A in a calendar data list of the memory 130 by using the ID information of the portable terminal A to identify the portable terminal A in step 203.

In step 203, the user of the portable terminal B may directly input and store a name of the user of the portable terminal A or specific information of the portable terminal A, and if there is no input from the user of the portable terminal B, the phone number of the portable terminal A may be stored by default.

During the connection between the portable terminal A and the portable terminal B or after a release of the connection, the controller of the portable terminal A transmits the calendar data generated in step 201 to the portable terminal B in step 204. The controller 110 of the portable terminal B then stores the received calendar data in the memory 130 in step 205.

In step 206, the portable terminal B determines if a calendar view mode is selected. Herein, the portable terminal B determines if the calendar view mode is selected if the controller 110 of the portable terminal B detects the selection of the calendar view mode. If the portable terminal B determines that a calendar view mode is not selected, a relevant function is performed. In contrast, if the portable terminal B determines that a calendar view mode is selected, the portable terminal B determines if predetermined calendar data is selected in the calendar view mode in step 207. Herein, the portable terminal B determines if the predetermined calendar data is selected in the calendar view mode if the controller 110 of the portable terminal B detects the selection of the predetermined calendar data.

If it is determined that the predetermined calendar data is selected in the calendar view mode, the controller 110 of the portable terminal B searches the selected calendar data for an owner field having ID information stored therein that matches registered ID information in step 208. Based on the results of the search, the controller 110 determines if the owner field having the ID information stored therein that matches the registered ID information exists in step 209. Herein, the controller 110 may determine if the owner field having the ID information stored therein that matches the registered ID information exists by detecting the presence of the owner field with the ID information stored therein and then determining if the detected ID information matches any registered ID information.

If the controller 110 determines that the owner field having the ID information stored therein that matches the registered ID information does not exist, that is if there is no owner field, no ID information stored in the owner field, or any detected ID information does not match the registered ID information, the controller 110 detects the absence of the owner field, the ID information stored in the owner filed, or any detected ID information does not match the registered ID information, and displays the selected calendar data on the display unit 160 in step 210.

In contrast, if the controller 110 determines that there is the owner field having the ID information stored therein for the selected calendar data, e.g., the ID information of the portable terminal A, exists in the calendar data list, the controller 110 displays the selected calendar data on the display unit 160 while displaying that the displayed calendar data is calendar data of the user of the portable terminal A in step 211.

As is apparent from the foregoing description, the exemplary embodiments of the present invention allow a user to recognize an owner of calendar data transmitted from a terminal to a terminal or from a computer to a terminal and displayed on the terminal, by providing a method for displaying calendar data while indicating an owner of the calendar data. Moreover, functions such as exchange diary, schedule management in the family, a personal assistant function, and the like can be applied in mobile terminals or programs.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for displaying calendar data, the method comprising:
generating, by a portable terminal, calendar data where IDentification (ID) information of the portable terminal is stored;
transmitting, by the portable terminal, the generated calendar data to a partner portable terminal; and
when displaying the transmitted calendar data in the partner portable terminal, indicating that the displayed calendar data is calendar data of a user of the portable terminal, by using the ID information of the portable terminal.

2. The method of claim 1, wherein the ID information is stored in an owner field of the calendar data.

3. The method of claim 1, wherein the ID information comprises at least one of a Bluetooth address and an ID number of the portable terminal.

4. The method of claim 1, wherein the transmitting of the generated calendar data comprises:
connecting the portable terminal with the partner portable terminal;
registering, by the partner portable terminal, the portable terminal in a calendar data list based on the ID information; and
transmitting, by the portable terminal, the generated calendar data to the partner portable terminal.

5. The method of claim 1, wherein the ID information of the portable terminal is received by the partner portable terminal through a connection between the portable terminal and the partner portable terminal.

6. The method of claim 1, wherein the portable terminal is connected with the partner portable terminal in one of a wired and wireless manner.

7. The method of claim 1, wherein the displaying of the transmitted calendar data comprises:
selecting the calendar data in a calendar view mode of the partner portable terminal;
determining whether ID information of the selected calendar data is identical to the ID information of the portable terminal registered in a calendar data list; and
if the ID information of the selected calendar data is identical to the ID information of the registered portable terminal, displaying the selected calendar data while indicating that the selected calendar data is calendar data of the user of the portable terminal.

8. The method of claim 7, further comprising displaying the selected calendar data if the ID information of the selected calendar data is not identical to the ID information of the registered portable terminal.

9. The method of claim 7, wherein the determining comprises:
determining whether an owner field exists in the selected calendar data; and
if the owner field exists in the selected calendar data, determining whether the ID information of the selected calendar data is identical to the ID information of the portable terminal registered in the calendar data list.

10. The method of claim 9, further comprising displaying the selected calendar data if the owner field does not exist in the selected calendar data.

11. A portable terminal for displaying calendar data, the terminal comprising:
a display for displaying calendar data to a user;
an input unit for receiving an input from the user;
at one least one of a wired and wireless communication unit for connecting and communicating with a partner portable terminal; and
a controller for controlling to receive calendar data generated by the partner portable terminal and for controlling to display the received calendar data with an indication that the displayed calendar data is calendar data of a user of the partner portable terminal based on ID information of the partner portable terminal.

12. The terminal of claim 11, wherein the ID information is included in an owner field of the received calendar data.

13. The terminal of claim 11, wherein the ID information comprises at least one of a Bluetooth address and an ID number of the partner portable terminal.

14. The terminal of claim 11, wherein the controller, when controlling to receive the calendar data generated by the partner portable terminal, controls to be connected with the partner portable terminal, controls to register the partner portable terminal in a calendar data list based on the ID information, and controls to receive the calendar data including the ID information.

15. The terminal of claim 11, wherein the ID information of the partner portable terminal is received through a connection with the portable terminal.

16. The terminal of claim 11, wherein the connection with the partner portable terminal is one of a wired and wireless connection.

17. The terminal of claim 11, wherein the controller, when controlling to display the received calendar data, controls to receive a selection of the calendar data in a calendar view mode, controls to determine whether ID information of the selected calendar data is identical to the ID information of the partner portable terminal registered in a calendar data list, and if the ID information of the selected calendar data is identical to the ID information of the registered partner portable terminal, controls to display the selected calendar data while indicating that the selected calendar data is calendar data of the user of the partner portable terminal.

18. The terminal of claim 17, wherein the controller, when controlling to display the received calendar data, controls to display the selected calendar data if the ID information of the selected calendar data is not identical to the ID information of the registered partner portable terminal.

19. The terminal of claim 17, wherein the controller, when determining, controls to determine whether an owner field exists in the selected calendar data, and if the owner field exists in the selected calendar data, controls to determine whether the ID information of the selected calendar data is identical to the ID information of the partner portable terminal registered in the calendar data list.

20. The terminal of claim 19, wherein the controller controls to display the selected calendar data if the owner field does not exist in the selected calendar data.
